(19) United States
(12) Patent Application Publication
(10) Pub. No.: US 2018/0134864 A1
(43) Pub. Date: May 17, 2018

(54) CROSSLINKABLE RUBBER COMPOSITION

(71) Applicant: Akzo Nobel Chemicals International B.V., Amhem (NL)

(72) Inventors: Weiqi CAO, Tianjin (CN); Shaogang XU, Beijing (CN); Waldo Joseph Elisabeth BEEK, Deventer (NL); Auke Gerardus TALMA, Bathmen (NL); Jan Martijn VAN DER SCHUUR, Hengelo (NL); Daan WILLINK, Renkum (NL)

(21) Appl. No.: 15/567,641

(22) PCT Filed: Apr. 20, 2016
(86) PCT No.: PCT/EP2016/058687

§ 371 Date: Oct. 19, 2017

(30) Foreign Application Priority Data
Apr. 23, 2015 (CN) PCT/CN2015/077277
Jun. 16, 2015 (EP) 15172278.2

(51) Int. Cl. C08K 3/06; C08K 5/14; C08K 5/00; C08K 3/04; C08K 3/36; C08J 3/24

(52) U.S. Cl. CPC C08K 3/06; C08K 5/14; C08K 5/0025; B60C 1/0016; C08K 3/36; C08J 3/247; C08K 3/04

(57) ABSTRACT

A crosslinkable rubber composition comprising:—natural rubber or a rubber blend comprising natural rubber and 0-25 wt % EPDM,—elemental sulfur—one or more sulfur cure accelerators or sulfur donors, and—at least one organic peroxide with a 10 hour half-life in monochlorobenzene at a temperature in the range 95-145′C, wherein the weight ratio of the total amount of sulfur cure accelerators and sulfur donors relative to the amount of elemental sulfur is not higher than 2.5, and wherein the composition is substantially free of non-diene rubber.

The present invention relates to a crosslinkable rubber composition and its use in the production of tyres. The composition allows for the production of sulfur-cured rubber with anti-reversion properties.

Natural rubber and blends containing natural rubber are conventionally crosslinked (cured) using elemental sulfur, one or more sulfur cure accelerators, and optionally a sulfur-donor.

Sulfur-cured rubbers, however, show cure reversion at high curing temperatures and the stability of the polysulfide crosslinks have poor aging resistance as a result of rearrangements between the polysulfide crosslinks, cyclic sulfides and free sulfur. Reversion decreases the crosslink density and reduces the physical properties, like resilience, modulus, hardness, and dynamic properties.

There are three basic sulfur cure systems: conventional vulcanisation (CV) systems, semi-efficient vulcanisation (SEV) systems, and efficient vulcanisation (EV) systems.

EV systems use a low level of elemental sulfur and a high level of sulfur cure accelerator and are mainly used for vulcanisates for which an extremely high heat and reversion resistance is required. EV systems, however, lead to poor tensile and tear strengths, poor flex-fatigue life, and abrasion resistance. The weight ratio of sulfur cure accelerators plus sulfur donors relative to elemental sulfur in these systems is in the range 2.5-12.

On the other side of the spectrum are CV systems, which use a high level of elemental sulfur and a low level of sulfur cure accelerator. The weight ratio of sulfur cure accelerators plus sulfur donors to elemental sulfur in these systems is in the range 0.1-0.7. These systems have higher flexibility and better dynamic properties, but have lower heat and reversion resistance than EV systems.

SEV systems are intermediate systems, which find a compromise between the two extremes discussed above. The weight ratio of sulfur cure accelerators plus sulfur donors to elemental sulfur in these systems is in the range 0.7-2.5.

Natural rubber-based tyres (e.g. truck tyres) are especially prone to reversion, because the cure time required to ensure heat transfer to the middle of a tyre is rather long. As a result, parts on the outside of the tyre tend to over-cure, which leads to reversion. Furthermore, during use of a car tyre, the temperature in some parts of the tyre, such as tread-base, can become very high, which also leads to reversion.

Cure reversion does not occur when rubbers are cured with organic peroxide instead of sulfur. However, peroxide cure is disadvantageous in terms of lower scorch safety, cure rate, sensitivity to oxygen inhibition, and poor dynamical properties. Therefore, they are presently not used in tyre manufacturing.

Mixed cure systems, which use both sulfur and an organic peroxide, are also known. In these systems, the cure process not only results in the formation of polysulfide crosslinks, but also in the formation of C—C crosslinks, initiated by the organic peroxide. The peroxides used for this purpose decompose at the cure temperature that is applied.

The dynamic properties of these mixed cure systems are, however, not as good those of CV systems.

The object of the present invention is therefore to provide an SEV or CV cure system which allows the formation of crosslinked rubber that is less prone to reversion without negatively impacting the dynamic properties.

The present invention therefore relates to a crosslinkable rubber composition comprising:
natural rubber or a rubber blend comprising natural rubber and 0-25 wt % EPDM,
elemental sulfur,
one or more sulfur cure accelerators or sulfur donors, and
at least one organic peroxide with a 10 hour half-life in monochlorobenzene at a temperature in the range 95-145° C. wherein the weight ratio of the total amount of sulfur cure accelerators and sulfur donors relative to the amount of elemental sulfur is not higher than 2.5, and wherein the composition is substantially free of non-diene rubber.

Preferably, the weight ratio of the total amount of sulfur cure accelerators and sulfur donors relative to the amount of elemental sulfur is not higher than 1.5, most preferably not higher than 1.0.

The rubber composition comprises natural rubber (NR), either as the only rubber or as a blend with one or more other types of rubbers. Examples of such other types of rubbers include styrene butadiene rubber (SBR) and butadiene rubber (BR).

The rubber blend contains 0-25 wt % EPDM (ethylene-propylene diene monomer), preferably 0-20 wt % EPDM, more preferably 0-10 wt % EPDM, and most preferably is free of EPDM. EPDM is very prone to radical cure and will therefore consume a large amount of the organic peroxide, which is then unavailable as anti-reversion agent.

The composition is substantially free of non-diene rubber, which means that the composition contains less than 0.1 wt %, preferably less than 0.05 wt %, more preferably less than 0.01 wt % of non-diene rubber. Most preferably, the composition is free of non-diene rubber.

Non-diene rubbers are rubbers that don't have double bonds and cannot be co-vulcanized with diene rubbers. Nor can they be sulfur vulcanized. Furthermore, they have a polarity that significantly differs from that of diene rubbers. This means that their presence would lead to an inhomogeneous system; inhomogeneous systems are undesired in the present invention.

Examples of non-diene rubbers are ethylene-propylene rubber (EPM), ethylene-butene rubber (EBM), propylene-butene rubber (PBM), fluorine rubber (FKM), epichlorohydrin rubber (CO, ECO), acrylic rubber (ACM), chlorinated polyethylene (CM), chlorosulfonated rubber (CSM), silicone rubber (Q), and uretane rubber (U).

The organic peroxide has a 10 hour half-life temperature in the range 95-145° C., more preferably 110-130° C., even more preferably 110-125° C., and most preferably 110-120° C. This 10 hour half-life temperature—the temperature at which 50% of the peroxide decomposed in 10 hours—is measured by differential scanning calorimetry-thermal activity monitoring (DSC-TAM) using a 0.1 molar dilute solution of the peroxide in monochlorobenzene. The reason for this relatively high half-life temperature is that (most of) the organic peroxide should survive the sulfur-cure.

Preferred organic peroxides are di(tert-butylperoxyisopropyl)benzene, tert-butyl cumyl peroxide, 2,5-dimethyl-2,5-di(tert-butylperoxy)hexyne-3,3,6,9-triethyl-3,6,9,-trimethyl-1,4,7-triperoxonane, dimethyl-2,5-di(tert-butylperoxy)hexane, and blends thereof.

The organic peroxide is preferably present in the crosslinkable composition of the present invention in an amount of 0.1-10 phr (weight parts per hundred weight parts of rubber), more preferably 0.2-5 phr, and most preferably 0.5-2 phr, calculated as pure peroxide.

“Phr” means: weight parts per hundred weight parts of rubber.

The term “elemental sulfur” refers to a compound with the formula Sₙ wherein n is at least 1 and thus includes sulfur in its atomic, oligomeric, cyclic and/or polymeric state.

Sulfur is preferably used in the process of the present invention in an amount of 0.1-2.5 phr, more preferably 0.5-2.5 phr, and most preferably 0.8-2 phr.

Examples of suitable sulfur cure accelerators and sulfur donors are benzothiazoles, benzothiazole sulfenamides, dithiocarbamates, and thiurams.

Examples of benzothiazoles are 2-mercaptobenzothiazole and 2,2′-dithiobisbenzothiazole.

Examples of benzothiazole sulfenamides are N-t-butyl-2-benzothiazole sulfenamide, N-cyclohexyl-2-benzothiazole sulfenamide, 2-morpholinothiobenzothiazole, and N-dicyclohexylbenzothiazole-2-sulfenamide. N-cyclohexyl-2-benzothiazole sulfenamide is a preferred sulfur cure accelerator, because it does not liberate unsafe nitrosamines upon use.

Examples of thiurams are thiuram polysulfides and thiuram monosulfides.

Thiuram polysulfides include thiuram disulfides, thiuram trisulfides, thiuram tertrasulfides, and thiuram hexasulfides, wherein thiuram disulfides are the preferred thiurams.

Examples of thiuram disulfides are tetrabutylthiuram disulfide, tetramethylthiuram disulfide, tetraethylthiuram disulfide, isobutylthiuram disulfide, dibenzylthiuram disulfide, tetrabenzylthiuram disulfide, and tetra-isobutylthiuram disulfide. Tetrabenzylthiuram disulfide (TBzTD) is a preferred sulfur cure accelerator because it does not liberate unsafe nitrosamines upon use.

Examples of thiuram tetra- and hexasulfides are dipentamethylenethiuram tetrasulfide and dipentamethylenethiuram hexasulfide, respectively.

Examples of dithiocarbamares are bismuth dimethyldithiocarbamate, cadmium diethyldithiocarbamate, cadmium diamyldithiocarbamate, copper dimethyldithiocarbamate, lead diamyldithiocarbamate, lead dimethyldithiocarbamate, selenium diethyldithiocarbamate, selenium dimethyldithiocarbamate, tellurium diethyldithiocarbamate, piperidinium pentamethylene dithiocarbamate, zinc diamyldithiocarbamate, zinc diisobutyldithiocarbamate, zinc diethyldithiocarbamate, zinc dimethyldithiocarbamate, copper dibutyldithiocarbamate, sodium dimethyldithiocarbamate, sodium diethyldithiocarbamate, sodium dibutyldithiocarbamate, zinc di-n-butyldithiocarbamate, and zinc dibenzyldithiocarbamate.

Examples of thiuram monosulfides are tetramethylthiuram monosulfide, isobutylthiuram monosulfide, dibenzylthiuram monosulfide, tetrabenzylthiuram monosulfide, and tetra-isobutylthiuram monosulfide.

The composition may also contains silica, carbon black, or a combination thereof.

The total amount of these fillers is preferably 10-160 phr, more preferably 30-120 phr, and most preferably 40-90 phr.

Suitable silicas are high dispersability grades, which are known to be suitable for tyre tread compounds.

The term “carbon black” includes carbon black, graphite, and activated carbon.

Examples of types of carbon black are oil furnace black (petroleum black), gas furnace black, acetylene black, lamp black, flame black (smoke black), channel black (carbon black obtained by small-flame combustion), thermal black, and electrically conductive carbon black. Electrically conductive carbon black differs from the other carbon blacks by its extremely high specific surface area.

The carbon particulates preferably have an average particle size of 0.1-300 microns, more preferably 0.5-150 microns, and most preferably 1-100 microns.

Examples of commercially available carbon blacks are N550 (Fine extrusion furnace grade) ex-Cabot and N330 (HAF, high abrasion furnace grade) ex-Cabot.

Examples of commercially available electrically conductive carbon blacks are Ketjenblack® EC-300JD and Ketjenblack® EC-600JD (ex AkzoNobel) and Ensaco® and Super P® conductive carbon black (ex Timcal).

Examples of commercially available graphites are Graphit UFZ 99.5, Graphit UF2 96/96, expandable graphite ES200 A5 (all ex Graphit Kropfmühl AG), expandable graphite type 2151 (ex Bramwell Graphite AG), and Timtex® graphite (ex Timcal).

Other conventional rubber additives may also be present in the crosslinkable composition of the present invention, such as clay, chalk, talc, aluminium hydroxide, magnesium hydroxide, zinc oxide, and calcium carbonate, lubricants, tackifiers, waxes, antioxidants, pigments, UV-stabilization agents, antiozonants, blowing agents, nucleating agents, extender oils, e.g. paraffinic and naphthenic oils, other rubber/tyre process oils like treated distillate aromatic extract (TDAE) oils, voltage stabilizers, water tree retardants, metal deactivators, coupling agents, dyes, and colorants. If used, such additives are to be used in an amount sufficient to give the intended effect.

Co-agents, in particular silicone elastomers, poly-maleimides (including bis- and tris-maleimides) and poly-citraconimides (including bis- and tris-citraconimides) do not need to be present in the composition of the present invention and are therefore preferably absent from the composition.

The composition can be made by thoroughly mixing all ingredients, preferably at a temperature in the range 50-150° C., more preferably 50-100° C. Mixing can be achieved in various ways, as is known to the skilled person. For instance, the ingredients may be mixed on a variety of apparatuses including multi-roll mills, screw mills, continuous mixers, compounding extruders, and Banbury mixers, or dissolved in mutual or compatible solvents. The process is preferably performed by first making a blend of the rubber (blend) and any optionally added additives that will not react with the elastomer, for instance in a Banbury mixer or a continuous extruder. This blend is then further mixed on a temperature controlled mill, for instance a two-roll mill, where the sulfur, sulfur cure accelerator(s) and/or sulfur cure donor(s), and the organic peroxide are added, and the milling is continued until an intimate mixture of all the components is obtained. The rolls are preferably kept at a temperature in the range of about 70-110° C. The composition is removed from the mill in the form of a sheet, and cooled.

After shaping the crosslinkable composition of the present invention in its desired form, it can be cross-linked at a preferred temperature of from 140° C., more preferably 150° C., and most preferably 160° C., up to 250° C., more preferably up to 220° C., most preferably up to 200° C.

Crosslinking may take 10 minutes up to 10 hours.

The resulting crosslinked composition finds use in tyre treads, undertreads, tyre side walls, conveyor belts, industrial hoses, bridge bearings, anti-vibration systems.

### EXAMPLES

### Comparative Example 1

Natural rubber (NR SVR-3L) was intimately mixed with carbon black (FEF-N550; Fine Extrusion Furnace and HAF-N330; High Abrasive Furnace), oil (Vivatec 500; a TDAE type of extender oil), and stabilizers (Santoflex 6PPD-pst and Flectol TMQ-pst) using a 1.2 L internal mixer. On a two-roll-mill, operating at a temperature in the range 50-70° C., sulfur, sulfur cure accelerators (CBS: N-cyclohexylbenzothiazole-2-sulfenamide; and TMTD-70: 70% tetramethylthiuram disulfide formulated on a elastomer carrier), ZnO, stearic acid, and—in experiment 2—peroxide were added to the rubber composition.

The peroxide used was di(tert-butylperoxyisopropyl)benzene (Perkadox® 14-40B-PD), which has a 10 hour half-life in monochlorobenzene at 114° C.

The total amount of sulfur cure accelerators and—donors versus elemental sulfur was 3.5 (=(5.04+(0.7*8.9))/3.2).

Viscoelastograph (Gottfert Visco Elastograph) data were obtained at 180° C. in accordance with ISO 6502-1991 (Measurement of vulcanization characteristics with rotorless curemeters).

The results are listed in Table 1, which indicates:

t90: time to 90% of maximal torque,

ML: minimum torque level,

MH: maximum torque level,

delta S=MH-ML,

MF: final torque recorded after completion of the indicated experiment time.

Reversion is the decrease in torque after reaching a maximum. The amount of reversion (in %) is calculated as:

reversion=100%*(MH−MF)/(MH−ML).

The reversion has been determined after 30 and 120 minutes, because the reversion is time dependent.

Table 1 shows that even an efficient vulcanization (EV) system, having a large amount of accelerators/donors, is susceptible to reversion. The addition of peroxide only leads to marginal improvements.

TABLE 1

| | | Exp. 1 | Exp. 2 | Δ reversion |
|---|---|---|---|---|
| Rubber (NR SVR-3L) | phr | 100 | 100 | |
| FEF-N550 | phr | 30 | 30 | |
| HAF-N330 | phr | 20 | 20 | |
| VivaTec 500 | phr | 8 | 8 | |
| Santoflex 6PPD-pst | phr | 2 | 2 | |
| Flectol TMQ-pst | phr | 1 | 1 | |
| ZnO | phr | 5 | 5 | |
| Stearic acid | phr | 0.5 | 0.5 | |
| S | phr | 3.2 | 3.2 | |
| CBS | phr | 5.04 | 5.04 | |
| TMTD-70 | phr | 8.9 | 8.9 | |
| Perkadox 14-40B-PD | phr | | 2.24 | |
| t90 | min | 0.61 | 0.62 | |
| ML | Nm | 0.08 | 0.07 | |
| MH | Nm | 1.51 | 1.59 | |
| Delta S | Nm | 1.43 | 1.51 | |
| MF (30 min) | Nm | 0.94 | 1.05 | |
| Reversion (30 min) | % | 40% | 36% | −4% |
| MF (120 min) | Nm | 0.64 | 0.79 | |
| Reversion (120 min) | % | 61% | 52% | −9% |

### Example 2

Comparative Example 1 was repeated using the compounds and amounts listed in Table 2. TBBS-80 is N-t-butyobenzothiazole-2-sulfenamide formulated to 80% on elastomer carrier; DTDM-80 is 4,4′-dithiodimorpholine formulated to 80% on elastomer carrier.

The total amount of sulfur cure accelerators and—donors versus elemental sulfur was 1.05 (=(0.8*(1.3+0.4))/1.3).

TABLE 2

| | | Exp. 3 | Exp. 4 | Δ reversion |
|---|---|---|---|---|
| NR SVR-3L | phr | 100 | 100 | |
| FEF-N550 | phr | 30 | 30 | |
| HAF-N330 | phr | 20 | 20 | |
| VivaTec 500 | phr | 8 | 8 | |
| Santoflex 6PPD-pst | phr | 2 | 2 | |
| Flectol TMQ-pst | phr | 1 | 1 | |
| ZnO | phr | 6 | 6 | |
| Stearic acid | phr | 1 | 1 | |
| S | phr | 1.3 | 1.3 | |
| TBBS-80 | phr | 1.3 | 1.3 | |
| DTDM-80 | phr | 0.4 | 0.4 | |
| Perkadox 14-40B-PD | phr | | 2.24 | |
| t90 | min | 1.20 | 1.50 | |
| ML | Nm | 0.09 | 0.08 | |
| MH | Nm | 0.82 | 0.90 | |
| Delta S | Nm | 0.73 | 0.82 | |
| MF (30 min) | Nm | 0.48 | 0.75 | |
| Reversion (30 min) | % | 47% | 18% | −29% |
| MF (120 min) | Nm | 0.48 | 0.76 | |
| Reversion (120 min) | % | 46% | 17% | −29% |

This experiment shows that in an SEV system, the effect of the peroxide on the reversion is very significant: almost a 30% decrease.

### Comparatve Example 3

Experiment 4 of Example 2 was repeated, except that a blend of natural rubber and EPDM was used.

The amounts of carbon black, extender oil and stabilizers relative to the amount of natural rubber were equal to those of Example 2.

TABLE 3

| | | |
|---|---|---|
| NR SVR-3L | phr | 66.7 |
| EPDM Keltan 5470 | phr | 33.3 |
| FEF-N550 | phr | 20 |
| HAF-N330 | phr | 13.3 |
| VivaTec 500 | phr | 5.3 |
| Santoflex 6PPD-pst | phr | 1.3 |
| Flectol TMQ-pst | phr | 0.7 |
| ZnO | phr | 6 |
| Stearic acid | phr | 1 |
| S | phr | 1.3 |
| TBBS-80 | phr | 1.3 |
| DTDM-80 | phr | 0.4 |
| Px14-40B-pd | phr | 2.24 |
| ML | Nm | 0.09 |
| MH | Nm | 0.72 |
| MF 30′ | Nm | 0.62 |
| MF 120′ | Nm | 0.53 |
| MF 180′ | Nm | 0.49 |
| Reversion 30′ | [%] | 16% |
| Reversion 120′ | [%] | 30% |

EPDM and NR do not mix very well and form two phases: an EPDM phase and a NR phase. Since EPDM is very susceptible to peroxide crosslinking, the peroxide will prefer the EPDM phase of the NR phase, which negatively affects the formation of peroxide-induced crosslinks in the NR phase. This will ultimately lead to failure after exposure to high temperatures (reversion).

Table 3 shows that the reversion of the EPDM-containing composition showed a continuing increase in reversion beyond 30 minutes.

### Example 4

Example 2 was repeated using different peroxides. For proper comparison, the same molar amounts of peroxide, based on expected crosslink efficiency, were used.

The following peroxides were used:

Trigonox® 29-40B-PD—40 wt % 1,1-di(tert-butylperoxy)-3,3,5-trimethylcyclohexanone (10 hour half-life temperature: 85° C.) on CaCO₃

Perkadox® BC-40B-PD—40 wt % dicumyl peroxide (10 hour half-life temperature: 112° C.) on CaCO₃

Perkadox® 14-40B-PD—40 wt % di(tert-butylperoxyisopropyl)benzene (10 hour half-life temperature: 114° C.) on CaCO₃

Trigonox® 101-45B-PD—45 wt % 2,5-dimethyl-2,5-di(tert-butylperoxy)hexane (10 hour half-life temperature: 115° C.) on CaCO₃

Trigonox® 145-45B-PD—45 wt % 2,5-dimethyl-2,5-di(tert-butylperoxy)hexyne-3 (10 hour half-life temperature: 120° C.) on CaCO₃

Trigonox® 311-50D-PD—50 wt % 3,3,5,7,7-pentamethyl-1,3,4-trioxepane (10 hour half-life temperature: 147° C.) on silica

Table 4 shows that Trigonox® 29 and Trigonox® 311 are ineffective in restoring the reversion, whereas peroxides with a 10 hour half-life in the claimed range are much more effective.

TABLE 4

| | | | | | | | | |
|---|---|---|---|---|---|---|---|---|
| NR SVR-3L | phr | 100 | 100 | 100 | 100 | 100 | 100 | 100 |
| FEF-N550 | phr | 30 | 30 | 30 | 30 | 30 | 30 | 30 |
| HAF-N330 | phr | 20 | 20 | 20 | 20 | 20 | 20 | 20 |
| VivaTec 500 | phr | 8 | 8 | 8 | 8 | 8 | 8 | 8 |
| Santoflex 6PPD-pst | phr | 2 | 2 | 2 | 2 | 2 | 2 | 2 |
| Flectol TMQ-pst | phr | 1 | 1 | 1 | 1 | 1 | 1 | 1 |
| ZnO | phr | 6 | 6 | 6 | 6 | 6 | 6 | 6 |
| Stearic acid | phr | 1 | 1 | 1 | 1 | 1 | 1 | 1 |
| S | phr | 1.3 | 1.3 | 1.3 | 1.3 | 1.3 | 1.3 | 1.3 |
| TBBS-80 | phr | 1.3 | 1.3 | 1.3 | 1.3 | 1.3 | 1.3 | 1.3 |
| DTDM-80 | phr | 0.4 | 0.4 | 0.4 | 0.4 | 0.4 | 0.4 | 0.4 |
| Trigonox 29-40B-PD | phr | | 4.03 | | | | | |
| Perkadox BC-40B-PD | phr | | | 3.67 | | | | |
| Perkadox 14-40B-PD | phr | | | | 2.24 | | | |
| Trigonox 101-45B-PD | phr | | | | | 2.15 | | |
| Trigonox 145-45B-PD | phr | | | | | | 1.7 | |
| Trigonox 311-50D-PD | phr | | | | | | | 1.88 |
| t90 | min | 1.2 | 1.41 | 1.23 | 1.5 | 1.45 | 1.2 | 1.28 |
| ML | Nm | 0.09 | 0.11 | 0.1 | 0.08 | 0.09 | 0.09 | 0.1 |
| MH | Nm | 0.82 | 0.87 | 0.89 | 0.9 | 0.89 | 0.86 | 0.85 |
| Delta S | Nm | 0.73 | 0.76 | 0.8 | 0.82 | 0.8 | 0.76 | 0.74 |
| MF (120 min) | Nm | 0.482 | 0.493 | 0.599 | 0.757 | 0.723 | 0.655 | 0.516 |
| Reversion | % | 46% | 50% | 37% | 17% | 21% | 27% | 45% |
| Δ reversion | % | | 4% | −9% | −29% | −25% | −19% | −1% |

Trigonox® 29 is the fastest peroxide in the tested series and decomposes at the temperature of sulfur crosslinking.

Trigonox® 311 is the slowest peroxide and its formation of C—C crosslinks apparently becomes too slow. A sulfur cure network has already established before the formation of a significant amount of C—C crosslinks, thereby hindering the diffusion of radicals into the already crosslinked matrix. Any produced radicals are presumably lost by side reactions and recombination.

### Example 5

Example 4 was repeated, except for using different amounts of the following peroxides:

Trigonox® 101-45D-PD—45 wt % 2,5-dimethyl-2,5-di(tert-butylperoxy)hexane (10 hour half-life temperature: 115° C.) on silica

Trigonox® 145-45B-PD—45 wt % 2,5-dimethyl-2,5-di(tert-butylperoxy)hexyne-3 (10 hour half-life temperature: 120° C.) on CaCO₃

The dynamic properties of the crosslinked composition were determined by dynamic mechanical analysis on a rubber test piece (38×13×2 mm) using an Anton Paar Physica MCR 301, at 60° C., a strain of 0.5%, and a frequency of 1 Hz. Reported in Table 5 is Tan Delta—the ratio of storage and loss modulus—which is a measure of the energy dissipation of the material. The lower this value, the better the rolling resistance.

TABLE 5

| | | | | | | | | | | |
|---|---|---|---|---|---|---|---|---|---|---|
| NR SVR-3L | phr | 100 | 100 | 100 | 100 | 100 | 100 | 100 | 100 | 100 |
| FEF-N550 | phr | 30 | 30 | 30 | 30 | 30 | 30 | 30 | 30 | 30 |
| HAF-N330 | phr | 20 | 20 | 20 | 20 | 20 | 20 | 20 | 20 | 20 |
| VivaTec 500 | phr | 8 | 8 | 8 | 8 | 8 | 8 | 8 | 8 | 8 |
| Santoflex 6PPD-pst | phr | 2 | 2 | 2 | 2 | 2 | 2 | 2 | 2 | 2 |
| Flectol TMQ-pst | phr | 1 | 1 | 1 | 1 | 1 | 1 | 1 | 1 | 1 |
| ZnO | phr | 6 | 6 | 6 | 6 | 6 | 6 | 6 | 6 | 6 |
| Stearic acid | phr | 1 | 1 | 1 | 1 | 1 | 1 | 1 | 1 | 1 |
| S | phr | 1.3 | 1.3 | 1.3 | 1.3 | 1.3 | 1.3 | 1.3 | 1.3 | 1.3 |
| TBBS-80 | phr | 1.3 | 1.3 | 1.3 | 1.3 | 1.3 | 1.3 | 1.3 | 1.3 | 1.3 |
| DTDM-80 | phr | 0.4 | 0.4 | 0.4 | 0.4 | 0.4 | 0.4 | 0.4 | 0.4 | 0.4 |
| Trigonox 101-45D-PD | phr | 0.5 | 1 | 2.15 | 4 | | | | | — |
| Trigonox 145-45B-PD | phr | | | | | 0.5 | 1 | 1.7 | 4 | — |
| t90 | min | 1.00 | 0.99 | 1.00 | 54.33* | 1.01 | 1.01 | 0.99 | 8.11* | 1.15 |
| ML | Nm | 0.08 | 0.08 | 0.08 | 0.08 | 0.07 | 0.08 | 0.08 | 0.08 | 0.08 |
| MH | Nm | 0.61 | 0.62 | 0.63 | 0.71 | 0.64 | 0.62 | 0.65 | 0.75 | 0.69 |
| Delta S | Nm | 0.53 | 0.54 | 0.55 | 0.63 | 0.57 | 0.54 | 0.57 | 0.67 | 0.61 |
| MF(120 min) | Nm | 0.51 | 0.48 | 0.55 | 0.71 | 0.44 | 0.51 | 0.51 | 0.75 | 0.47 |
| Reversion 120′ | % | 19 | 26 | 15 | 0 | 35 | 20 | 25 | 0 | 36 |
| Median Tan delta | | 0.118 | 0.120 | 0.111 | 0.104 | 0.128 | 0.128 | 0.118 | 0.113 | 0.141 |
| (cure 3 min) | | | | | | | | | | |
| Median Tan delta | | 0.180 | 0.165 | 0.135 | 0.141 | 0.175 | 0.169 | 0.160 | 0.127 | 0.187 |
| (cure 120 min) | | | | | | | | | | |
| difference | | 0.062 | 0.045 | 0.024 | 0.037 | 0.047 | 0.041 | 0.042 | 0.014 | 0.046 |

*Marching cure

Table 5 shows that it is possible to completely stop the reversion, while maintaining good dynamic properties (tan delta).

1. A crosslinkable rubber composition comprising:
natural rubber or a rubber blend comprising natural rubber and 0-25 wt % EPDM,
elemental sulfur,
one or more sulfur cure accelerators or sulfur donors, and
at least one organic peroxide with a 10 hour half-life in monochlorobenzene at a temperature in the range 95-145° C.,
wherein the weight ratio of the total amount of sulfur cure accelerators and sulfur donors relative to the amount of elemental sulfur is not higher than 2.5, and wherein the composition is substantially free of non-diene rubber.

2. Crosslinkable rubber composition according to claim 1 wherein the weight ratio of the total amount of sulfur cure accelerators and sulfur donors relative to the amount of elemental sulfur is not higher than 1.5.

3. Crosslinkable rubber composition according to claim 2 wherein the weight ratio of the total amount of sulfur cure accelerators and sulfur donors relative to the amount of elemental sulfur is not higher than 1.0.

4. Crosslinkable rubber composition according to claim 1 wherein the organic peroxide is selected from the group consisting of di(tert-butylperoxyisopropyl)benzene; tert-butyl cumyl peroxide; 2,5-dimethyl-2,5-di(tert-butylperoxy)hexyne-3; 3,6,9-triethyl-3,6,9,-trimethyl-1,4,7-triperoxonane; dimethyl-2,5-di(tert-butylperoxy)hexane; and blends thereof.

5. Crosslinkable rubber composition according to claim 1 wherein the elemental sulfur content of the composition is in the range 1.0-3.5 phr (per hundred rubber).

6. Crosslinkable rubber composition according to claim 1 wherein the content of sulfur cure accelerators plus sulfur donors in the composition is in the range 0.4-2.5 phr (per hundred rubber).

7. Crosslinkable rubber composition according to claim 1 wherein the organic peroxide content of the composition is in the range 0.1-5 phr (per hundred rubber).

8. Crosslinkable rubber composition according to claim 1 containing silica and/or carbon black in an amount of 10-70 phr (per hundred rubber).

9. Crosslinkable composition according to claim 1 wherein the rubber blend is selected from the group consisting of styrene butadiene rubber (SBR), butadiene rubber (BR), and combinations thereof.

10. Crosslinkable composition according to claim 1 wherein the rubber blend comprises less than 20 wt % of EPDM.

11. Crosslinkable composition according to claim 10 wherein the rubber blend comprises less than 10 wt % EPDM.

12. Crosslinkable composition according to claim 11 wherein the composition is free of EPDM.

13. An automobile tire comprising the composition according to claim 1.

14. Process for crosslinking a rubber composition comprising the steps of
a. providing a rubber composition according to claim 1 and
b. heating the composition at a temperature in the range 140-250° C.
